(19) United States
(12) Patent Application Publication
(10) Pub. No.: US 2005/0119907 A1
(43) Pub. Date: Jun. 2, 2005

(54) Method for generating at least one project reference model, method for generating structured configuration information by means of such a project reference model, as well as devices for performing, managing, and organizing such methods

(76) Inventor: Peter Dilger, Hugelshofen (CH)

Correspondence Address: NATH & ASSOCIATES, PLLC, Sixth Floor, 1030 15th Street, N.W., Washington, DC, 20005-1503, US

(21) Appl. No.: 10/920,437

(22) Filed: Aug. 18, 2004

(30) Foreign Application Priority Data
Aug. 22, 2003 (DE) 103 39 112.6

(51) Int. Cl. G06F 17/60

(52) U.S. Cl. 705/1; 717/105

(57) ABSTRACT

The invention relates to a method for generating at least one project reference model, a method for generating structured configuration information by means of such a project reference model, as well as a device for executing, managing, and organizing such methods. Here, the following processing steps are essential: preparation of a preset project reference model in a memory arrangement with at least one classification scheme, which contains various classification elements, wherein each classification element refers to at least one memory location, in which information for this classification element is stored; representation of the preset project reference model on a display device; generation of a new project reference model from the preset project reference model by means of an input device according to preset organization-specific and/or service-specific conditions; representation of the new project reference model on the display device; and storage of the new reference configuration model.

The invention relates to a method for generating at least one project reference model, a method for generating structured configuration information by means of such a project reference model, as well as devices for performing, managing, and organizing such methods.

### BACKGROUND OF THE TECHNOLOGY

In large companies and organizations, there are many projects, which frequently have similar structures and features and which are worked on in parallel and many times independently from each other. For the planning, performance, and maintenance of projects, there are aids in the form of general or certified procedural models, specifications, and regulations and also to a limited extent systemic solutions. However, these systems and solutions support the projects only to a small degree and if at all, only in their content-specific performance and in this regard also only in a very limited way.

Reasons for the inadequate systemic support are primarily complex structures, procedures, and relationships, which cannot be standardized or normalized without reference models or project reference models.

Individual projects themselves can be planned, performed, and maintained only insufficiently in terms of reuse and standardization without the use of such project reference models for detailed processes, effects, and procedures. Previously known project management and project organization applications or project portals do support the systemic preservation of project structures with contents, roles, report matters, and also associated applications. However, the generation of new project processes and procedures is incumbent on the users and the operators, who must generate or prepare these processes and procedures themselves manually and thus very individually. As a result, the projects are always re-invented from the beginning, because, if at all, prior knowledge is considered only insufficiently.

Large organizations constantly strive to improve the content-specific support of their project processes. However, such improvement depends on the extent of understanding about successful project processes and procedures, including possible alternative processes and procedures and their relationships to each other. In large organizations, often hundreds or even thousands of projects are worked on in parallel. Frequently, they receive no or only minimal systemic, theoretical, and empirical support in reusable and gained knowledge according to the “best practice” principle. In this principle, components, which have proven to be good, are taken over from an individual, processed, and completed project. In contrast, unproven project parts and/or sections are modified manually or completely reshaped by hand. The modification of such projects must be performed individually and is thus expensive. The result is that the systemic support for advancing the understanding by these processes and procedures and the development of improved processes and procedures is greatly impaired. The development of systemic, standardized, and reusable capacities in the form and in the use of project reference models thus offers large organizations a great opportunity and the ability to provide in a systematic way new or proven models, methods, and solutions in daily project work.

The consequently unrecognized possibilities for automation and improvement in the creation, use, and refinement of project standards leads to the fact that developments and investments are misdirected and are always concerned with the preparation of electronic guidelines, instructions, and other aids. However, the users are responsible for their proper use, which requires much understanding, a great amount of engagement, and extensive training. Only a very minimal use frequently stands opposite the great expenses. Thus, among other things it should be explained that just in Germany, every year losses of several billion Euros are generated in industry and organizations due to project goals unattained in terms of delivery dates, economics, and content.

However, through standardization and automation, planning and development reliability can be improved significantly.

The existing problem becomes even more clear when the current situation is illuminated with the example of vehicle development.

In projects of significant size and priority, the industry today is organized such that it details the processes and structures of the large project and sets so-called delivery or quality gates or other reporting points for the assurance deadlines. Thus, a view over the usually complex overall structure should be maintained and the progress of the project, e.g., for vehicle development, should be controllable and manageable. The assurance information to be prepared for these processes and reporting points from the structure or the course of the entire procedure must be given by the appropriate responsible parties. This product development process (PEP) defined for the vehicle development is usually standardized and certified and is used by the management for coordinating many individual processes and thus for coordinating associated individual projects.

Even for the large majority of projects supplying the gates, which projects require particular specialization, up to now neither automated systems nor suitable standardization mechanisms in the form of suitable project organization and project development applications have been prepared. The responsible parties charged with the execution or conversion are left to their own devices. There is no proven universal systemic support, because the complex, specific, and detailed project structures with partial projects or work packets associated with suitable applications, methods, models, information, documents, and data, are not generated in practice today, and thus are frequently reorganized and restructured individually. Automated adjustments with higher-order processes and projects running in parallel are not possible today. Possible standardizations of project portfolios, project kinds or project types with content-specific and associated project processes, also up to the gates of the PEP, are not known by the responsible parties and they also do not concern themselves therewith due to the “time to market” pressure and they also do not see creation of improvements as their task. Thus the common ground remains too small to enable systematic support for adjusting results with aggregation upwards and drill-down downwards with all of the functions required for the management and the project work up to managing skills also within detailed project structure elements, such as those of work packets.

As a result, enormous costs are incurred by the automotive industry in the development of new vehicles, it loses valuable knowledge through changing employees, and misses chances to better manage its entire process and thus to be able to act more economically and more flexibly.

Until today, no defined method for generating and using extensive standardized project reference models has yet become known. There are still no systems, which suitably prepare reference models for projects and which allow arbitrary modifications, inheritance, and links, and which make available the contents of project reference models in machine-readable language for configuration purposes into user or target systems and thus for practical application in project work. Thus, there is also still no device, which manages a multitude of project reference models of differing specialization and expression as project kinds or project types and which can prepare same summarized in portfolios. Previously there were no methods, which enabled the manual and automatic generation of project configuration information in order to configure off-the-shelf and future systems with this information for the organization and execution of specific projects automatically and with the help of project reference models.

The present invention addresses exactly this situation.

The invention has the goal of presenting a suitable method for generating at least one project reference model. In addition, a method for generating structured configuration information by means of such a project reference model is proposed and also devices for executing, managing, and organizing such methods are presented.

The method for generating at least one reference configuration model is the object of claim 1.

A method for generating structured configuration information by means of such a project reference model is the object of claim 11.

Finally, in claim 16, a device for executing, managing, and organizing such methods is given.

Refinements of the invention are the object of the subordinate claims.

According to the invention, the method for generating at least one project reference model, which defines the process requirements and their control in a machine-readable way, executes the following processing steps:
preparation of a preset project reference model in a memory arrangement with at least one classification scheme, which contains various classification elements;
representation of the preset project reference model on a display device;
generation of a new project reference model from the preset project reference model by means of an input device according to preset organization-specific and/or service-specific conditions;
representation of the new project reference model on the display device;
storage of the new project reference model;
the classification elements are stored in a first memory with their individual designations and memory-location references on at least one other memory;
information going beyond the designations of the classification elements are stored in the at least one other memory;
for generating the new project reference model, the at least one other memory is accessed exclusively over a preceding access to the first memory.

Here, a standardizable and reusable part of a systemic configuration support of project management and project organization applications, project portals, and project processes is meant as the project reference model, with which the configuration information can be structured and prepared in a machine-readable way.

Microsoft Project 2000—Instructor Edition Complete; Custom-Guide, Inc.; 2002; pages 1-43 describes a method for creating and managing so-called Project Templates. Such MS project templates are distinguished in that one can define and fill free columns. However, the possible information in these columns cannot be structured further. In a MS project template, no sub-structures can be reused in other MS project templates. Such project templates normally have a single logical/physical memory, i.e., a file or database.

In contrast, according to the characterizing portion of claim 1, several logical and/or physical memories are used, whereby a separation of classification elements and additional information is possible for the later generation of structured configuration information.

Through this separate arrangement of memories, all of the model elements of a project reference model (classification scheme, classification elements) can be used in an arbitrary number of project reference models. Thus, a reuse of sub-structures (e.g., recurring organization project structures) can be achieved.

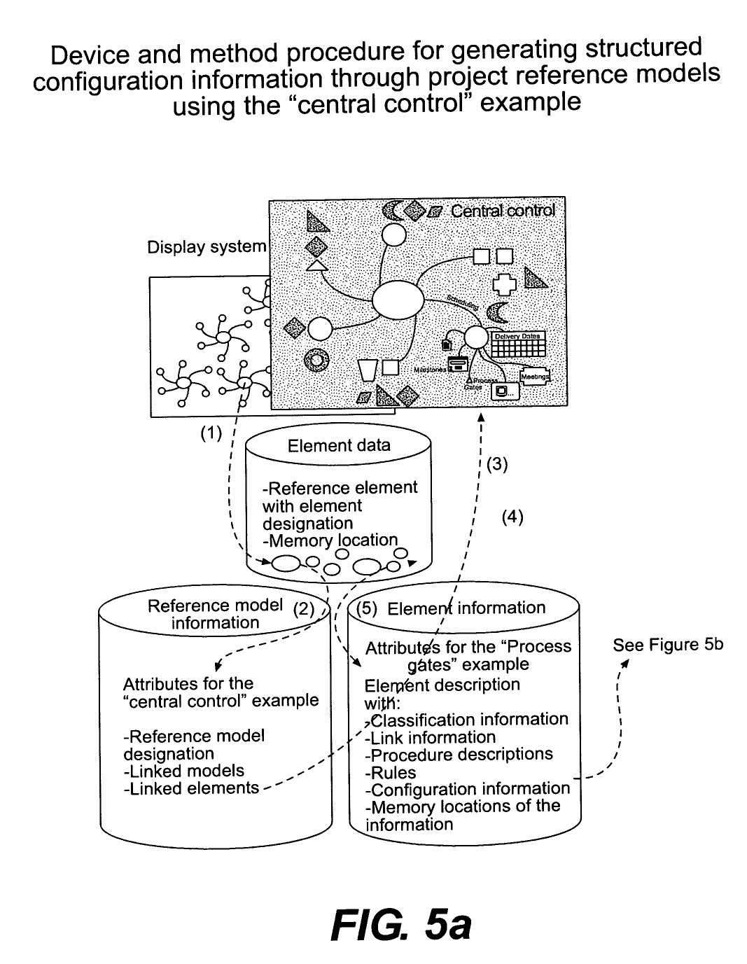

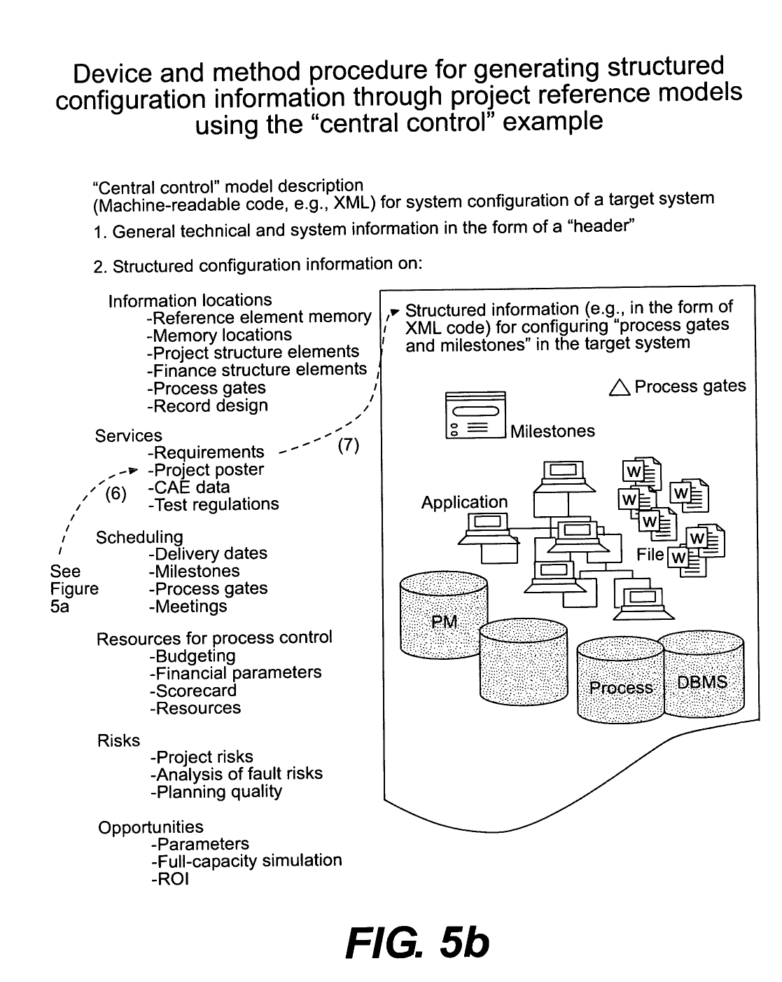

The presence of several logical and/or physical memories has been disclosed in detail in the present applicant documents in association with FIGS. 5a and 5b as well as the associated description.

In the above-mentioned document “Microsoft Project 2000,” the MS project templates can be sorted in a classification scheme based on the operating-system functionalities of MS Windows. However, only a hierarchical organization structure can be displayed.

The essential difference with the object of claim 1 is in the management of classification elements in several memories. Only in this way is it possible to be able to use the classification elements in arbitrarily complex structures, which are set in relation to each other by means of classification element links.

The following consideration also shows that the method described in “Microsoft Project 2000” differs in principle from the method claimed in the new claim 1. For a storage as project model and subsequent storage in the sense of one as a project reference model, in “Microsoft Project 2000” as an MS project template, for the method according to “Microsoft Project 2000” the relation between the project reference models is lost. In particular, modifications, such as specializations (e.g., expanding a derived project reference model by additional classification elements, replacing a classification element by a variant), aggregation (e.g., integrating a “vehicle” project reference model with a “software components” project reference model), thus are not displayed, because no links are present anymore. An MS project template contains project information as total information in a single memory. Thus, however, the changes performed in new project reference models to the allocation of classification elements cannot be subsequently executed, while in contrast, with claim 1 a detailed sequence of changes is possible.

In another refinement of the invention, the project reference model is created, such that classification elements are allocated manually to a classification scheme in a computer system, wherein a designation is given and a memory location in one memory device is allocated to the classification elements. Then, the information necessary for the classification element is stored in the memory location.

In the following, for better understanding of the term used in the following, project reference model is defined in more detail and the properties as well as the purpose of such project reference models is explained.

Brief Definition:

A project reference model is a standardization model, which enables specific project or process development, application, and organization information in the form of machine-readable configuration instructions and data for the setting and configuration of one or more target systems, in which the projects or processes are planned, executed, or maintained. The project reference models include information on applications, application functions, procedures, processes, methods, documents, data, other organization aids, and interfaces.

Properties:

A project reference model includes classification elements, which are organized in classification schemes and which reference in turn the actual configuration information for applications, application functions, procedures, processes, methods, documents, data, other organization aids, and interfaces. The classification elements and their reference structures can be organized arbitrarily and underlie the logic of each model defined by the user. The logic of the model is generated by classification and link types, procedural descriptions, rules, data, and other meaningfully expandable descriptions of the elements.

Setup:

A project reference model is the display of the logical structure and display of classification elements and their attributes, the reference to information in terms of applications, application functions, procedures, processes, methods, documents, data, other organization aids, and interfaces to be configured, as well as their information in terms of their memory locations at which this information has actually been stored. A project reference model displays the setup and procedure of project-specific or process-specific procedures, structures, and information on its specific classification elements and their allocation as machine-readable configuration information.

Purpose:

A project reference model is used to make available the use of the standardizable parts of a project or process and its specialization in the form of applications, application functions, procedures, processes, methods, documents, data, other organization aids, and interfaces in the target systems by an automated configuration. The use of project reference models is performed in target systems such as project management, project organization or project portal applications and corresponding applications. The project reference model transfers to the target system or systems structured, machine-readable project configuration information.

Use:

A project reference model generates in a machine-readable descriptive language (e.g., XML) the necessary configuration information. The target system interprets this language and configures itself automatically with the contained configuration information. A prerequisite is that the target system support the specific properties of each project reference model with its functionalities.

The generation of project reference models can be performed using various means and methods. Project reference models can be coded directly with editors or generated with systemic support in the form of user interfaces, thus input devices, created for this purpose. There are the following possibilities:
1. Individual programming in a machine-readable descriptive language (e.g., XML);
2. Creation with systemic support by a suitable user interface, i.e., suitable user surfaces with guided dialogues. As a result, configuration information in a machine-readable descriptive language is available as under 1.;
3. Modeling in a system with graphic user interface, which is suitable for supplying descriptions and attributes in order to complete them in subsequent systems (subsequent system as described, e.g., in 2.).

In the generation types 2. and 3., the user can also be guided and supported by wizard functions (user guide with dialogues and selection options for actions and activating the execution for confirmation or selection by the user), as long as the system provides such a device.

Before project reference models can be generated, easily applicable and reusable classifications for managing and organizing the project reference models must be established for an organization. For this purpose, groups of project reference models are set in classifications and classification schemes (classification lists or classification structures) and described with their designations, types, functions, and contents. Another classification scheme images the allocation of classification elements within the project reference models. Reference structures indicate dependencies and uses of the classification elements within the project reference model and with respect to other project reference models. If corresponding classification schemes are provided, then these can also be adapted or expanded to the corresponding organizational requirements. This is achieved through the organization-specific adaptation or changing of existing classifications, classification schemes (classification lists or classification structures) and their designations, types, functions, and contents.

According to the invention, there are various options for generating a first and thus quasi-original generation project reference model:

1. Initialization of a Project Reference Model

A project reference model is developed without referring to already existing models. The classification elements are assigned classification schemes. The element information (attributes), consisting of the element designation and the element memory location, are created manually. Their references to the memory location or locations, where its own and other information in terms of classifications, links, procedures, rules, configuration information, data, and other descriptions are contained for the target system to be configured, are completed manually with the necessary information and data.

2. Extraction of a Project Reference Model from a Best-Practice Project

From a worked-out and proven project or process (best practice) within one or more target systems, the standardizable structure information for a project reference model is extracted. Here, the information described under 1. is filtered and prepared in machine-readable code for further processing or edited and modified with corresponding user-interface or wizard support.

3. Detailing of a Project Reference Model

An existing project reference model is detailed when it obtains more in-depth specialization. Here, new elements with references to the information are set or the references of the elements to each other are defined. With systemic support, a wizard can also be used.

4. Duplication of a Project Reference Model

An existing project reference model can be duplicated in order to use it, e.g., in another system, or to manage it at different points.

5. Inheritance of the Properties of a Project Reference Model

An existing project reference model transfers properties in the form of classifications and classification elements to a model generated from it. Here, individual classifications and classification elements or their entirety are transferred. The selection of the classifications and classification elements to be inherited is supported by a suitable user interface or a wizard according to systemic prerequisites.

6. Making Versions and Changing a Project Reference Model

An existing project reference model is changed. New classifications and classification elements can be added or existing ones can be removed. A new version of the project reference model is produced. When making versions, the original model continues to exist. Older versions can be accessed via an authorization system.

In addition to the method according to the invention for generating a project reference model, a method for generating structured configuration information by means of a project reference model generated according to the described method also lies within the scope of the present invention, wherein the method for generating the mentioned structured configuration information has the following processing steps:
1. selection of a project reference model displayed on a display device for each input device;
automatic release of a reference to a first memory, in which are stored designations of all classification elements and their memory location for further information;
automatic release of a reference to a second memory, in which are stored the information for the selected project reference model and references to linked project reference models and/or linked classification elements;
displays of all classification elements and classification schemes of the selected project reference model on the display device;
selection of the classification elements to be processed according to commands input by the input device;
display of the selected classification element and updated, automatic reference to the first memory;
determination of the memory location stored in the first memory for this selected classification element;
Finally, the device for executing the method according to the invention is characterized by the following features:
a display device;
a control device;
a first memory, in which are stored all classification elements with their individual designations, further information, and allocated memory locations, in which is stored information on these classification elements;
a second memory, which has the memory locations, in which the information for classification elements is stored, which characterizes project reference models;
at least one third memory, in which is stored the information for all other classification elements;
wherein the control device controls the access to at least three memories, such that the second and third memories can always be accessed just via an already performed access to the first memory.

The method according to the invention and its device are explained in more detail in the following with reference to schematic figures. Shown are:

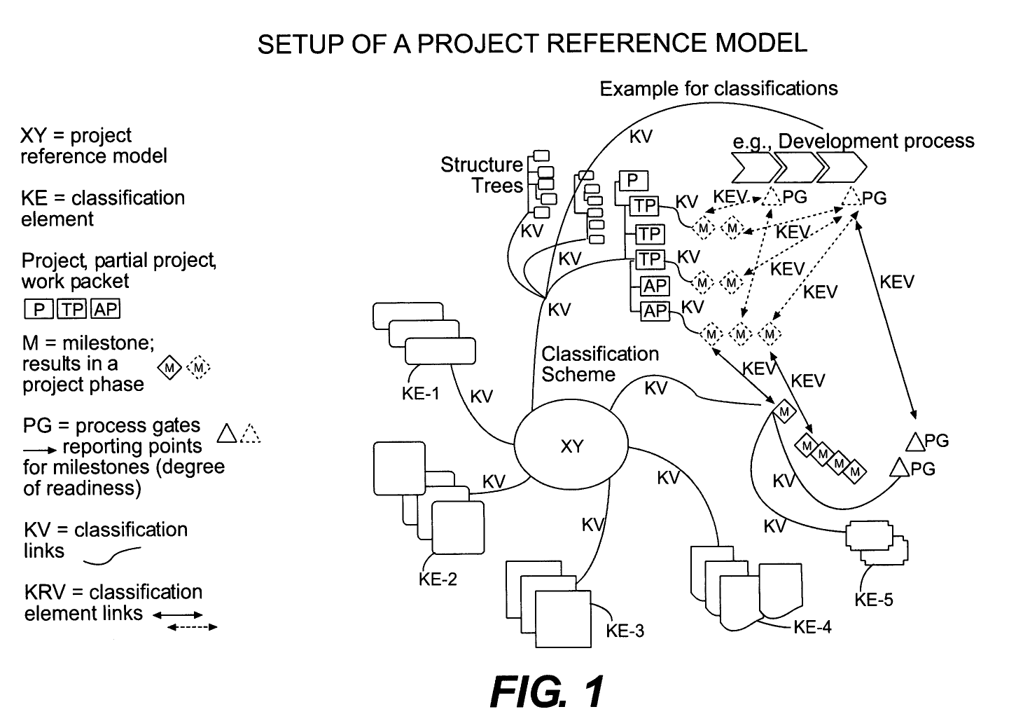

FIG. 1, the principle set-up of a project reference model,

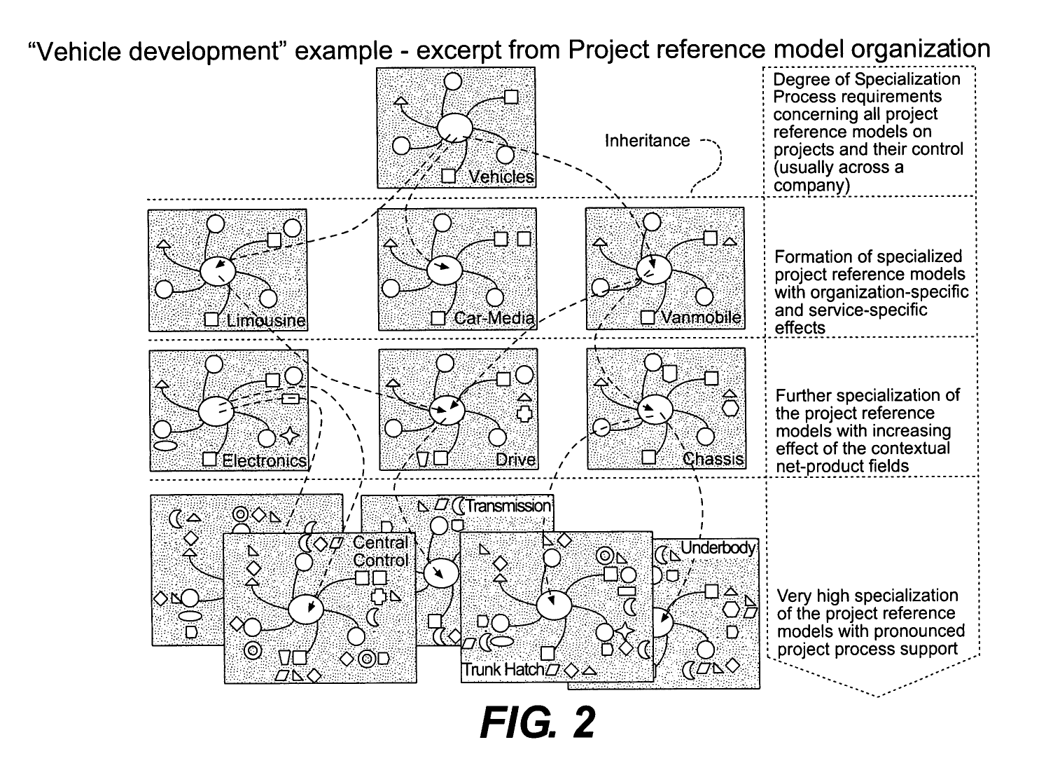

FIG. 2, the summary from a project reference model organization with the “vehicle development” example,

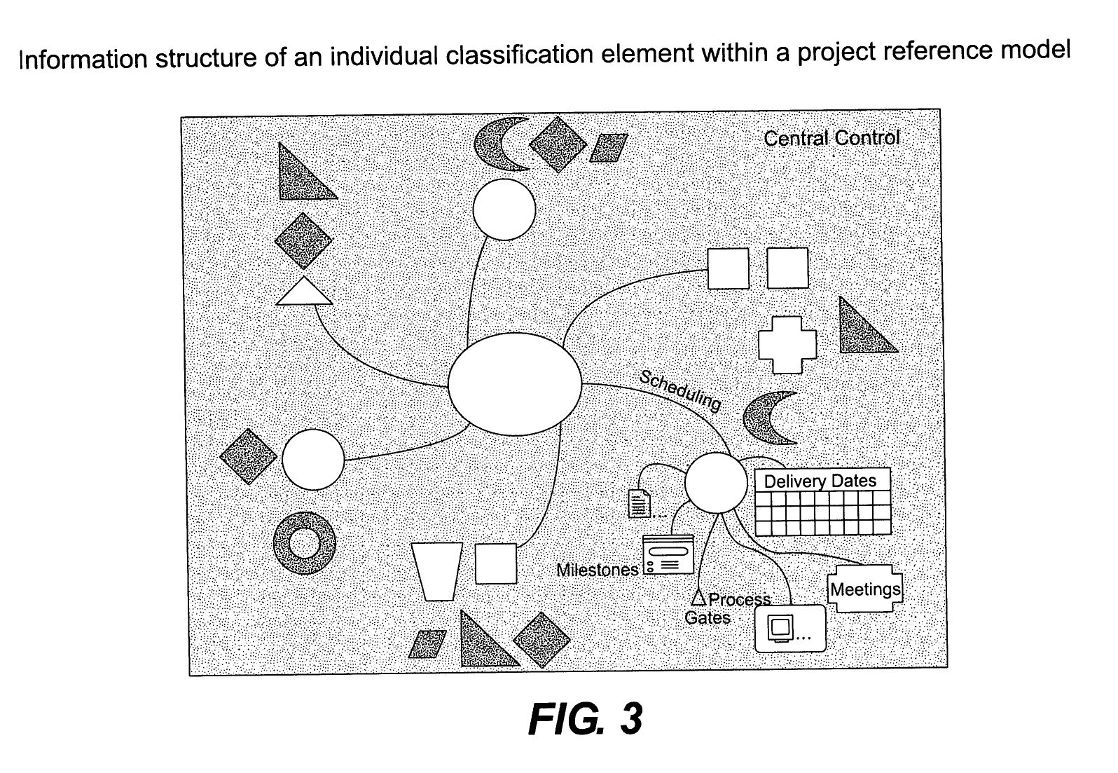

FIG. 3, a possible information structure of an individual classification element within a project reference model,

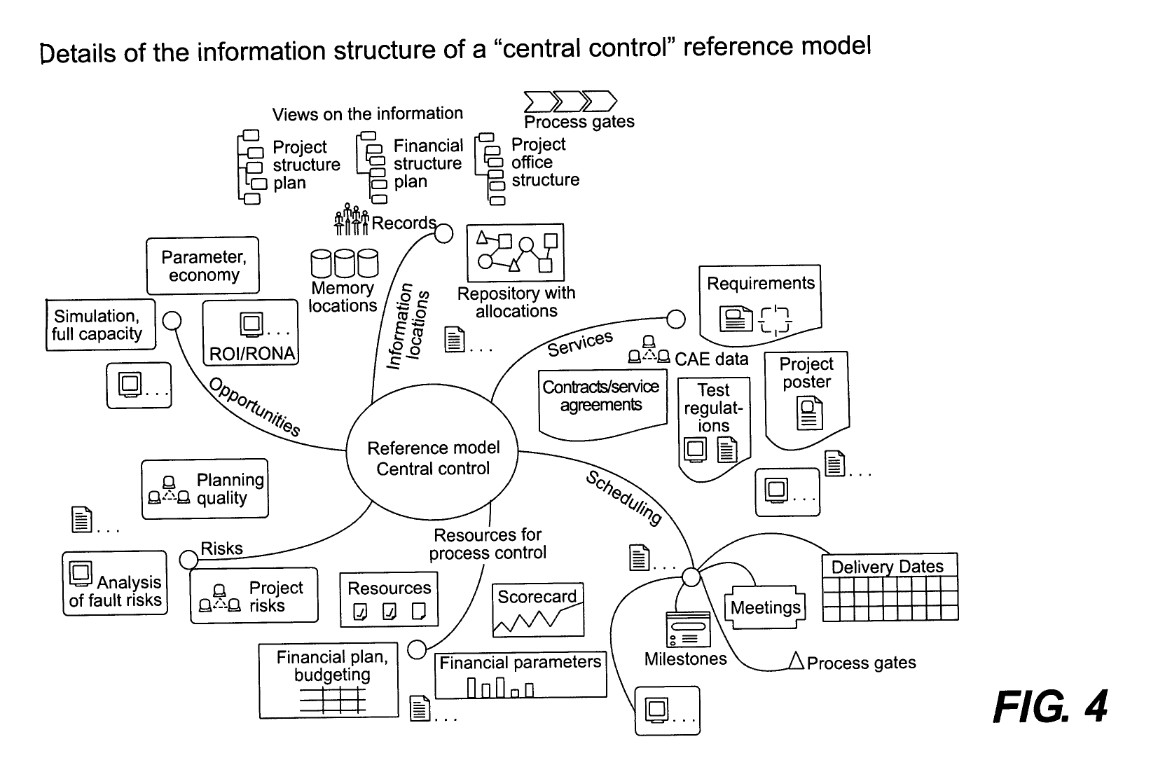

FIG. 4, example details of an information structure of a “central control” project reference model and

FIG. 5, the principle structure of a device including schematic representation of the associated method procedure for generating structured configuration information by project reference models for the “central control” example.

In FIG. 1, as an example the set-up of a project reference model is shown. Here, the project reference model carries the name XY and includes a classification scheme formed by connecting lines, so-called classification links KV, arrows, and so-called classification-element links KEV. In the illustrated classification scheme, classification elements KE are classified. These classification elements KE can be ordered by classification, can have links to other classification elements and their information or can point to a different memory. In the illustrated classification scheme, a multitude of classification elements KE1 . . . KE5 are sketched.

The classification scheme has, e.g., structure trees, provides information on various projects P, partial projects TP, and work packets AP, which are characterized by milestones M or results of a project phase. Finally, the entire classification scheme provides various so-called process gates PG, i.e., reporting points for certain milestones to be achieved.

The selected example of FIG. 2 shows as an example the summary from the organization of project reference models, like those that could be used by a vehicle manufacturer. The example shows a hierarchical excerpt to promote understanding. Actually, multidimensional network structures can be generated by the reference options within the classification scheme. Through inheritance, classification elements can be transferred and through expansion or specialization, new project reference models can be produced. Typically, the inherited classification elements are transferred at least partially or entirely to their successive (“children”) project reference elements.

The example of FIG. 2 shows the development of vehicles in a company. The “vehicle” reference model contains all relevant and general project-specific development information, which is passed on to the “limousine,” “car-media,” and “vanmobile” reference models and is expanded individually by their own specifications. The specializations could refer, e.g., to contextual net-product areas (products) or the project processes (procedures) and require expansion with the corresponding elements. Arbitrary record-specific views can be created in the form of portfolios.

As can be seen from FIG. 2, the degree of specialization increases hierarchically from top to bottom. The “vehicle” project reference model is the most general and as a rule the most distributed across the organization and contains such requirements that are in common for all projects and processes and their control in the organization.

The classification scheme and the classification elements of this general “vehicle” project reference model are transferred to or inherited by the “limousine,” “car-media,” and “vanmobile” project models. The specialization of these reference models is produced by adding specific classification and classification elements, which are necessary for these reference models. The newly added classifications and classification elements are shown in the second level from the top with a gray background.

Further specialization of the reference models is produced in the third level viewed from the top to the bottom according to FIG. 2. There, the “electronics,” “drive,” and “chassis” reference models are shown. The newly added classification elements are again shown graphically with a gray background.

Finally, located in the lowermost, fourth level viewed from the top are additional reference models for “central control,” “transmission,” “trunk hatch,” and “underbody.” This lowermost level of reference models is distinguished by very high specialization with pronounced project process support. The added new classifications and classification elements have a gray background. As can be seen from FIG. 2, the classification scheme is inherited from one level top to bottom.

In FIG. 3, as an example the information structure or the classification scheme of an individual classification element is shown within a project reference model. In the example, so-called process gates PG are present within the information structure. Such process gates PG are used in vehicle development as higher-order production reporting points in order to be able to monitor the progress of the vehicle manufacturing process. Because a vehicle development process consists of a plurality of partial processes and partial projects with additional granularity, project milestones are partially also allocated as the result reporting points to the process gates PG.

If, e.g., a classification element is called “central control process gate,” then according to the invention this classification element refers to a memory location, which can contain, e.g., the following element information:
classification information of this element,
link information between the “central control” process and the milestone plan,
procedural descriptions in terms of the reporter results, milestones, and process gates,
rules for the different reporter results at each process gate and milestone, and
systemic configuration information and data for a target system, in which the project is configured for execution.

Thus, the example of FIG. 3 shows a reference model, like one that could be used for the organization of the “central control” project (electronic central controller) as a component of the electronics for a limousine by a vehicle manufacturer. The information structure of the present reference model thus has general parts of the project processes and certain degrees of specialization, recognizable as more general and more specialized classification elements. The project reference model includes classification elements, which are organized into classification schemes and which refer in turn to the actual configuration information for applications, application functions, procedures, processes, methods, documents, data, other organization aids and interfaces.

In FIG. 4, the details of the information structure of a “central control” project reference model is shown as an example.

The “central control” reference classification model shown in FIG. 4 provides a classification scheme, in which information on risks, opportunities, information locations, services, scheduling, and resources for process control is provided. As risks, e.g., an analysis on fault risks as well as project risks and information on planning quality are stored as classification elements. The “simulation, full capacity,” “parameter, economy,” and “ROI-RONA” classification elements are allocated to the “opportunities” classification. As can be further seen from FIG. 4, at the information locations, among other things, a project structure plan, a financial structure plan, a project-office structure, and memory locations are stored as classification elements, just like so-called process gates. In terms of the “services,” “scheduling,” and “resources for process control” classifications, reference is made expressly to the labeling of FIG. 4.

In FIGS. 1-4, various classification elements were explained. These classification elements can be inherited, newly generated, modified, etc. In order to be able to characterize the possible state forms of these classification elements in a reference classification model, state codes are allocated to the classification elements. These state codes should be able to characterize the following various states of the classification elements.
1. Existent—the classification element exists, there is a link to information
2. Virtually deleted—the classification element exists, there is no link
3. Physically deleted—the classification element no longer exists
4. Changed—the classification element has been changed and contains the changed information
5. Versions made—the classification element has been changed and exists as a version
6. Inherited—the properties of the classification element are transferred to a new element (child)
7. Duplicated—a physical copy of the element exists.

In all, it can be determined that the classification elements of a project reference model are ordered by classification schemes. Which elements are arranged how in a classification scheme depends on a plurality of factors. Effects or features belong to the most important criteria for the setup of a classification scheme:
existing company or field model (organization form, branch)
general regulations, standards, and methods in projects
project types (research project, development project, production project, marketing project, . . . )
record and function structures (financial structure, logistics control, controlling, etc.)
requirements on logging and reporting
. . .

In FIG. 5, the device and the method procedure for generating structured configuration information by project reference models is explained with the “central control” example.

The selected example shows the excerpt from the organization of project reference models, like those that could be used by a vehicle manufacturer. The “central control” project is selected.

Description of the Device and the Method Procedure:
(1) The “central control” project reference model is selected from a “display system.” It refers to an “element data” memory, which knows the designations of the elements and their memory location for further information.
(2) The memory location refers to the “reference model information” memory. This contains all of the elements, which belong to this “central control” project reference model.
(3) The display system allows the viewing and processing selection of all elements of the “central control” project reference model.
(4) The “process gates” and “milestones” elements selected by the display system refer to the memory location of the “element information” through their “element data” memory.
(5) The attributes present there for the “process gates” example, the element descriptions of classification information, link information to other models or elements and procedure descriptions, rules, configuration information, memory locations of further information, and further descriptive features or effects are determined for the configuration description.
(6) Structured information in the form of machine-readable code (e.g., XML) is generated for the “process gates” and “milestones” elements and arranged according to the classification structure.
(7) The present structured information for configuring target systems now exists accordingly.
   The target system can thus be configured automatically and take over the information of the project reference model as well as here the “process gates” and “milestones” elements as well as their dependency and automatically execute its descriptive configuration. The target system keeps the configuration information ready for the user, so that he can set up, adapt the information individually to the requirements, and use at any time a “central control” project.
   List of Reference Symbols
AP Work packet
KE 1-5 Classification elements 1 to 5
KEV Classification element link
KV Classification links
M Milestones
P Project
PG Project gate (reporting points)
TP Partial project

1. Method for generating at least one project reference model, which defines project and process requirements and their control in a machine-readable way with the following processing steps:
preparation of a preset project reference model in a memory arrangement with at least one classification scheme, which includes various classification elements;
representation of the preset project reference model on a display device;
generation of a new project reference model from the preset project reference model by means of an input device according to preset organization-specific and/or service-specific conditions;
representation of the new project reference model on the display device; and
storage of the new reference configuration model;
characterized by the following processing steps:
the classification elements are stored in a first memory with their individual designations and memory location references to at least one other memory;
information going beyond the designations of the classification elements is stored in the at least one other memory;
for generating the new project reference model, the at least one other memory is accessed exclusively by means of a preceding access to the first memory.

2. Method according to claim 1, characterized in that the preset project reference model is created, in that classification elements are allocated to a classification scheme in a computer system, wherein the classification elements give a designation and a memory location is allocated in a memory device and wherein in the memory location information on these classification elements is stored.

3. Method according to claim 2, characterized in that the information includes classifications, links, procedures, rules, and configuration information, data, as well as other descriptions for a target system to be configured.

4. Method according to claim 1, characterized in that the preset project reference model is obtained from an already worked-out and proven project or process (best practice).

5. Method according to caim 1, characterized in that in the memory location, to which a classification element refers, in addition to the information for this classification element, also its link to other classification elements is stored.

6. Method according to claim 1, characterized in that the generation of the preset project reference model is performed by detailing, in that at least one new classification element and/or at least one new classification scheme is allocated to the preset project reference model by means of a user interface.

7. Method according to claim 1, characterized in that the generation of the new project reference model is performed by duplicating the preset project reference model by means of the user interface.

8. Method according to claim 1, characterized in that the generation of the new project reference model is performed by inheriting properties of the preset project reference model, in that classification schemes and/or classification elements of the preset project reference model are transferred to the new project reference model, and wherein a user interface controls the selection of the classification scheme and/or classification elements to be transferred.

9. Method according to claim 1, characterized in that state codes are allocated to the classification elements.

10. Method according to claim 9, characterized in that the state codes refer to whether the corresponding classification element in the project reference model exists or has been virtually deleted, changed, made into versions, inherited, blocked, or duplicated.

11. Method for generating structured configuration information by means of a generated project reference model according to claim 1, wherein the following processing steps are provided:
selection of a project reference model displayed on a display device for each input device;
automatic release of a reference to a first memory, in which designations of all classification elements and their memory location for further information is stored;
automatic release of a reference to a second memory, in which the information for the selected project reference model and references to linked project reference models and/or linked classification elements is stored;
display of all classification elements and classification schemes of the selected project reference model on the display device;
selection of the classification elements to be processed according to commands input by the input device;
display of the selected classification elements and updated, automatic reference to the first memory;
determination of the memory location stored in the first memory for this selected classification element;
automatic reference to this memory location and retrieval of the information stored in this memory location;
conversion of the information retrieved from there into machine-readable code and arrangement in a classification structure.

12. Method according to claim 11, characterized in that for the presence of further references in the retrieved information, new references are made to the first memory in order to retrieve further information stored in the further memory locations.

13. Method according to claim 12, characterized in that the conversion of the retrieved information into machine-readable code is performed only when no more references are contained in the retrieved information.

14. Method according to claim 11, characterized in that after the conversion into machine-readable code, an automatic configuration of the target system or target systems is performed by transferring the information of the process project reference model and the selected classification elements.

15. Use of the method according to claim 1 in the planning of projects, project processes, and project-related development, production, and service processes, especially in big business and in automotive, communications, information-technology, and financial services businesses.

16. Device for executing a method according to claim 1 with the following features:
a display device;
a controller;
a first memory, in which all classification elements are stored with their individual designations, further information, and associated memory locations, in which information is stored on these classification elements;
a second memory, which has the memory locations, in which the information for classification elements is stored, which characterizes process project reference models;
at least a third memory, in which information for all other classification elements is stored;
wherein the controller controls the access to the three or more memories, so that the second or third memory can always be accessed only by means of an already performed access to the first memory.

17. Device according to claim 16, characterized in that information for all other classification elements is stored in the memory locations.

18. Device according to claim 16, characterized in that information for classification elements or references is contained in the third memory.

19. Device according to claim 16, characterized in that the controller has at least on input device, by means of which project reference models or classification elements that can be represented on the display device can be selected.

20. Device according to claim 17, characterized in that the input device is voice controlled.
